(19) United States
(12) Patent Application Publication
(10) Pub. No.: US 2025/0358606 A1
(43) Pub. Date: Nov. 20, 2025

(54) LOCALIZED UNIFIED DATA REPOSITORY (UDR) SUBSCRIPTION DISTRIBUTION FOR MARKET-BASED USER EXPERIENCE

(71) Applicant: T-MOBILE INNOVATIONS LLC, Overland Park, KS (US)

(72) Inventors: Anuj Sharma, Broadlands, VA (US); Deepesh Belwal, Ashburn, VA (US)

(21) Appl. No.: 18/663,664

(22) Filed: May 14, 2024

(51) Int. Cl. H04W 8/20; H04W 4/029

(52) U.S. Cl. CPC H04W 8/20; H04W 4/029

(57) ABSTRACT

Systems, methods, and devices are disclosed herein for sub-segmenting UDR segments in a 4G or 5G core network. Sub-segmentation of the UDR supports faster call flows, resource distribution flexibility, and regional promotion deployment. A wireless communication network in accordance with the present disclosure includes a UDR made up of two or more database segments, a lookup database that stores information indicating where each subscriber profile is stored, and at least one routing function. Each database segment of the UDR is further segmented into two or more subsegments. The at least one routing function is configured to receive requests for subscriber information, obtain the subscriber information from the UDR segment and subsegment identified by the lookup database, and respond to the request with the subscriber information.

### TECHNICAL FIELD

Various embodiments of the present technology relate to wireless communication networks and in particular to subscriber data access and management.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices include phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices. Exemplary network functions include the access and mobility management function (AMF), the policy control function (PCF), the unified data management function (UDM), and the unified data repository (UDR).

The UDR is a network entity that stores network and subscriber data. The subscriber data is organized into subscriber profiles that each correspond to a wireless user device subscribed for service on the network. The subscriber profiles store data like service attributes, network policy authorizations, mobility policies, and the like. The subscriber profiles are associated with the user devices based on device Identifiers (IDs) such as International Mobile Subscriber Identity (IMSI) numbers. When another network function (e.g., the UDM) needs to retrieve subscriber data to serve a user device, the network function accesses the subscriber profile stored by the UDR that is associated with that user device. The network function then serves the user device based on the retrieved subscriber data. Traditionally, the UDR is a monolithic database that stores the entire subscription base. However, such an approach places heavy reliance on a single data repository potentially creating a single point of failure. Additionally, the increase in Fifth Generation (5G) subscribers in wireless communication networks stresses the storage capacity of the UDR.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to the storage of subscriber information in wireless communication networks. More specifically, the technology disclosed herein includes the segmentation and sub-segmentation of the unified data repository (UDR) to support localized subscription distributions. In a first embodiment, a method of operating a wireless communication network includes: receiving a request for subscriber information associated with a subscriber stored in a database segment of a plurality of database segments, wherein each database segment of the plurality of database segments stores a different portion of subscriber profiles stored across the plurality of database segments; in response to the request, obtaining information indicating that the subscriber information associated with the subscriber is stored in an identified subsegment of the database segment, wherein the database segment is segmented into a plurality of subsegments; upon obtaining the information indicating that the subscriber information associated with the subscriber is stored in the identified subsegment of the database segment, retrieving the subscriber information associated with the subscriber from the identified subsegment of the database segment; and responding to the request with the subscriber information associated with the subscriber.

In some embodiments, each subsegment of plurality of the subsegments corresponds to a different geographic region and the identified subsegment of the database segment corresponds to a first geographic region. The method may further include applying a subscription feature to each subscriber profile currently stored in the identified subsegment corresponding to the first geographic region. The request for the subscriber information associated with subscriber may be triggered by a request from a user device associated with the subscriber to access the wireless communication network and the request from the user device associated with the subscriber may be sent from a second geographic region associated with a different subsegment of the plurality of subsegments. The method may further include, upon detecting that the request from the user device associated with the subscriber was sent from the second geographic region instead of the first geographic region, moving the subscriber information associated with the subscriber from the identified subsegment of the plurality of subsegments to the different subsegment of the plurality of subsegments. The method may further include, upon moving the subscriber information associated with the subscriber from the identified subsegment to the different subsegment of the plurality of subsegments, updating information in a lookup database to indicate that the subscriber information associated with the subscriber is stored in the different subsegment of the plurality of subsegments. The plurality of database segments, in some embodiments, make up a unified database repository (UDR) associated with the wireless communication network. The request, in some embodiments, is from an authentication entity of the wireless communication network. The authentication entity sends the request for the subscriber information associated with the subscriber in response to receiving an authentication request associated with the subscriber. The wireless communication network, in some embodiments, is a Fifth Generation (5G) cellular communication network.

In another embodiment, a wireless communication network includes a unified data repository (UDR) having two or more database segments, wherein each database segment of the two or more database segments stores a different portion of subscriber profiles in the UDR and each database segment of the two or more database segments is further segmented into two or more subsegments. The wireless communication network further includes a lookup database configured to store information indicating where each subscriber profile of the subscriber profiles in the UDR is stored. The network further includes at least one routing function configured to: receive a request for subscriber information associated with a subscriber stored in a database segment of the two or more database segments; in response to the request, obtain information from the lookup database indicating that the subscriber information associated with the subscriber is stored in an identified database segment of the two or more database segments and an identified subsegment of two or more subsegments making up the identified database segment; upon obtaining the information indicating that the subscriber information associated with the subscriber is stored in the identified database segment and the identified subsegment, retrieve the subscriber information from the identified subsegment in the identified database segment; and respond to the request with the subscriber information associated with the subscriber.

In yet another embodiment, one or more non-transitory computer-readable storage media have program instructions stored thereon that, when executed by a computing system, direct the computing system to perform operations including: receiving a request for subscriber information associated with a subscriber stored in a database segment of a plurality of database segments, wherein each database segment of the plurality of database segments stores a different portion of subscriber profiles stored across the plurality of database segments; in response to the request, obtaining information indicating that the subscriber information associated with the subscriber is stored in an identified subsegment of the database segment, wherein the database segment is segmented into a plurality of subsegments; upon obtaining the information indicating that the subscriber information associated with the subscriber is stored in the identified subsegment of the database segment, retrieving the subscriber information associated with the subscriber from the identified subsegment of the database segment; and responding to the request with the subscriber information associated with the subscriber.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communication network to in accordance with some existing communications technology;

FIG. 2 illustrates a wireless communication network in accordance with some embodiments of the present technology;

FIG. 3 illustrates information that may be stored in a Lookup UDR in accordance with some embodiments of the present technology;

FIG. 4 is a flowchart illustrating a series of steps performed in a wireless communication network in accordance with some embodiments of the present technology;

FIG. 5 is a flowchart illustrating a series of steps performed in a wireless communication network in accordance with some embodiments of the present technology;

FIG. 6 is a flowchart illustrating a series of steps performed in a wireless communication network in accordance with some embodiments of the present technology;

FIG. 7 illustrates a 5G wireless communication network according to one or more embodiments of the present technology;

FIG. 8 illustrates a Network Function Virtualization Infrastructure (NFVI) in the 5G wireless communication network according to one or more embodiments of the present technology; and

FIG. 9 illustrates a computing system suitable for implementing the various operational environments, architectures, processes, scenarios, and sequences discussed below with respect to the other Figures.

### DETAILED DESCRIPTION

Systems, methods, and devices are disclosed herein for segmenting and sub-segmenting data repositories in wireless networks, such as the unified data repository (UDR) in 5G core networks. The UDR is a database that stores network and subscriber data for purposes of network authentication and registration in network call flows. The UDR is accessed by other entities in the network core to retrieve data to serve a user, in which case the UDR may provide information such as a determined data rate, the quality of service, latency, authorized services, and the like. Modern UDRs are modeled in a distributed geo-redundant manner and have the ability to host billions of subscription entries in order to serve various telecommunications technologies such as 5G, LTE, IoT, IMS, and the like. Traditionally, the UDR is a monolithic database that stores the entire subscription base. However, such an approach places unnecessary reliance on a single data repository potentially creating a single point of failure.

To address the issues associated with hosting all subscriber profiles in a single UDR, network providers may segment the UDR into multiple UDR segments and distribute subscriber profiles across the multiple segments. A UDR may, in some cases, be segmented into two or more segments. Segmenting, as described herein, refers to dividing or portioning a dataset into smaller, more manageable segments based on specific criteria or attributes. Segmenting helps organize data in a structured manner, making it easier to locate and access information. Thus, in accordance with embodiments of the present disclosure, the UDR may be sliced into two or more segments based on, for example, IMSI numbers, core network functions, service types, or other segmentation criteria. For example, a first segment may comprise a group of network functions with low-latency capabilities while a second segment may comprise a group of network functions with standard capabilities.

Routing of provisioning and access requests to the right database segment happens with the help of a subscription lookup database. In some embodiments, the subscription lookup database, or lookup UDR, is accessed by various routing nodes (e.g., SCP, STP, DRA, DEA, SLF, Provisioning-Nodes, etc.) to figure out which segment a subscriber profile resides in. Once the appropriate UDR segment is identified, the routing functions access the UDR segment via one or more application segments associated with the UDR segment (e.g., HSS, UDM, EIR, and HLR).

Modern segmented UDR solutions, however, are deployed in such a manner that it is difficult (i.e., requires extensive effort, cost, and/or time) for operators to be able to provide market-based or region-based promotions, specialized customer experiences, and the like. Any such planned events have the potential to impact customers outside of the targeted market or region. Moreover, due to the way UDRs are segmented, maintaining health of the segmented UDR in cases of network outages becomes increasingly challenging as the size of the UDR grows.

Most modern segmentation criteria are based on either IMSI ranges or subscription types. These methods have limitations around market-specific promotions, which can generate high traffic that may impact subscription traffic across other markets due to the fact that all UDR front ends (FEs) receive traffic for subscriptions from all markets. However, increasing the scale of the entire UDR FE layer to support market-specific events is difficult (i.e., requires extensive effort, time, or money), slow, and inefficient.

Additionally, most modern UDRs are deployed in an access/storage (i.e., FE/BE) model, with subscription profile details stored on the storage (BE) layer and indexes to access that data (e.g., MSISDN, IMSI, IMPU, IMPI, SUPI, SUCI) stored on the access (FE) layer. Data provisioning and access requirements require that each FE node have access to all subscription data (i.e., the information stored in the BE nodes). Thus, most database implementations require a complete connection-mesh between all FE nodes and between each FE and all BE nodes across every deployed site (i.e., geo-redundant site requirements). However, this deployment implementation requires an extensive number of connections and poses challenges during network events or hiccups that break network connectivity. Moreover, restoring the network in such an implementation requires extensive resources and may impact data access and/or integrity.

Thus, in accordance with the technology disclosed herein, UDR segments are further divided into subsegments. The sub-segmentation of UDR segments greatly reduces the connection requirements between FE and BE nodes. In a sub-segmented UDR environment, the connection requirements are reduced to: (1) all FE nodes connect to all other FE nodes of the same subsegment, rather than all FE nodes on the entire UDR segment and (2) all BE nodes connect all BE and FE nodes of the same subsegment rather than all FE nodes of the entire segment. Sub-segmentation of the UDR further enables operators to provide targeted market-based or region-based solutions quickly, with less time, effort, and cost than would be required under existing UDR solutions.

Various technical effects may be appreciated from the implementations disclosed herein. Such technical effects include reducing the number of connections required to operate a segmented UDR (i.e., reducing connections between FE and BE database nodes), reducing the negative impact of increased network traffic on a regional basis, and reducing the number of affected subscribers during network outages. Additionally, technical effects include a reduction in cost and effort associated with market and/or region-based promotional events, improved functionality of 5G networks, improved functionality of subscription databases, and improved efficiency in the storage of network subscriber profiles. The systems and methods proposed herein also improve the robustness and resiliency of deployed UDR solutions in cases of overloads or network outages and allow for shorter recovery time after such events.

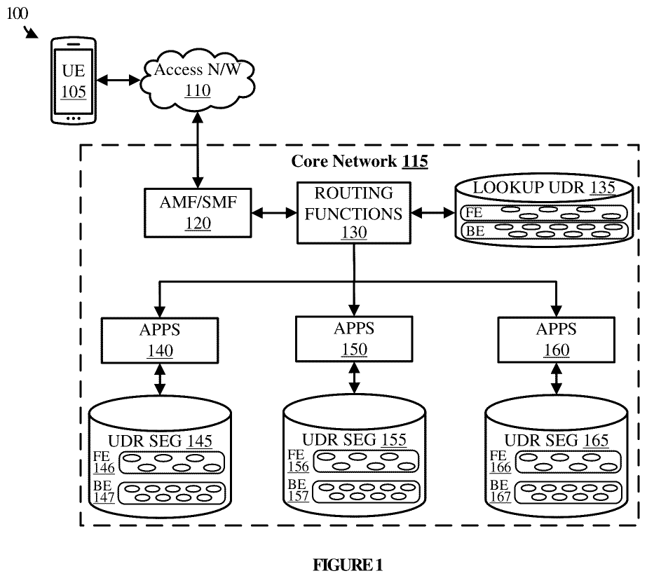

FIG. 1 illustrates communication network 100, which is representative of wireless communication network infrastructure in which the subscription database is hosted across three UDR segments. Communication network 100 delivers services like voice calling, machine communications, internet access, media streaming, or some other wireless/wireline communication product that may be provided to user devices. Communication network 100 includes user equipment (UE) 105, access network 110, and core network 115. Core network 115 includes AMF/SMF 120, routing functions 130, lookup UDR 135, applications 140, UDR segment 145, applications 150, UDR segment 155, applications 160, and UDR segment 165. UDR segment 145 includes front end (FE) 146 and back end (BE) 147. UDR segment 155 includes FE 156 and BE 157. UDR segment 165 includes FE 166 and FE 167. Routing functions 130 includes one or more of a service communication proxy (SCP), signal transfer point (STP), diameter routing agent (DRA), diameter edge agent (DEA), subscriber location function (SLF), and/or routing proxy. In other examples, communication network 100 may include additional or different elements than those included in FIG. 1.

In the present example, UDR segment 145, UDR segment 155, and UDR segment 165, in combination, store all subscriber profiles for users on communication network 100. However, in other examples, a different number of UDR segments may be implemented for storing subscriber profiles. The subscriber profiles stored in UDR segment 145, UDR segment 155, and UDR segment 165 include service attributes that define the level of service to be provided to users. For example, the subscriber profile for UE 105 may include data indicating the Quality-of-Service (QoS), bitrate, latency, mobility, policies, network policy authorization, and/or other metrics defining the level of service associated with UE 105. The entire subscriber profile for UE 105, however, is stored on only one UDR segment. The subscriber profile for UE 105 may therefore be stored in UDR segment 145 in the present example. Network entities within communication network 200 therefore read the service attributes associated with UE 105 stored in UDR segment 145 to provide wireless data services to UE 105 over access network 110.

UE 105 is representative of a wireless/wireline user device. Exemplary user devices include phones, smartphones, computers, vehicles, drones, robots, sensors, and/or other devices with wireless communication capabilities. Access network 110 exchanges wireless signals with UE 105 over radio frequency bands. The radio frequency bands use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access network 110 is connected to other components of the network over backhaul data links. Access network 110 exchanges network signaling and user data with other network elements in communication network 100.

Access network 110 may include wireless access nodes, internet backbone providers, edge computing systems, or other types of wireless/wireline access systems to provide wireless links to UE 105, backhaul links to components of core network 115, and edge computing services between the user devices and core network 115. The wireless access nodes of access network 110 may include Fifth Generation (5G) RANs, LTE RANs, gNodeBs, eNodeBs, NB-IoT access nodes, LP-WAN base stations, wireless relays, WIFI hotspots, Bluetooth access nodes, and/or other types of wireless or wireline network transceivers. The access nodes may include Radio Units (RUs), Distributed Units (DUs), and/or Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers closer to core network 115. The CUs handle higher wireless network layers like the Radio Resource Control (RRC), Service Data Adaption Protocol (SDAP), and Packet Data Convergence Protocol (PDCP). The CUs are coupled to network functions in core network 115.

Core network 115, in some examples, is representative of a 4G or 5G core network. Core network 115 includes computing systems that provide wireless data services to user devices (e.g., UE 105) over access network 110. Exemplary computing systems comprise data centers, server farms, network function virtualization infrastructure (NFVI), cloud computing networks, hybrid cloud networks, and the like. The computing systems of core network 115 store and execute the network functions to provide wireless data services to UE 105 over access network 110. The computing systems in core network 115 typically store and execute network functions to form a control plane (not illustrated) and a user plane (not illustrated) to serve UE 105 and other user equipment. The control plane may include network functions such as AMF/SMF 120, a policy control function (PCF), unified data management (UDM), and/or a home subscriber server (HSS). The user plan may include network functions like user plane function (UPF). Core network 115 may comprise Fifth Generation Core (5GC) architecture, an Evolved Packet Core (EPC) architecture, or the like.

AMF/SMF 120 is representative of the access and mobility management function (AMF) and the session management function (SMF). The AMF and SMF are core network functions that handle connectivity, mobility, and session management in core network 115. The AMF is responsible for access and mobility management including the initial registration of devices, authentication, tracking area management, and ensuring that users remain connected as they move through the network. The AMF serves as the point of contact for a user device (e.g., UE 105) when it tries to connect to the network (e.g., communication network 100). The AMF manages the establishment, maintenance, and termination of the connection between UE 105 and the core network. The session management function (SMF) is responsible for session management including establishing, modifying, and releasing sessions (which include one or more data flows). The SMF also selects and manages the user plane functions, handles aspects of IP address allocation, and maintains the rules for how data should be routed and reported. The SMF ensures that data can be successfully transmitted between UE 105 and the internet or other network services.

During an access call flow (i.e., southbound), the AMF accesses the UDR (i.e., one of UDR segment 145, UDR segment 155, or UDR segment 165) to retrieve and update access and mobility subscription information for a user. For example, when a user's device (e.g., UE 105) tries to connect to the network, the AMF queries one of UDR segment 145, UDR segment 155, or UDR segment 165 via one or more routing functions of routing functions 130 (e.g., SCP/STP, DRA/DEA, SLF, routing proxy, etc.) to authenticate the user and obtain their profile, which includes information such as the user's identity, security credentials, and access authorization. The one or more routing functions access lookup UDR 135 prior to obtaining the subscription information to look up which UDR segment the subscription resides in.

The SMF connects to one of UDR segment 145, UDR segment 155, or UDR segment 165 to retrieve session management subscription information. Before establishing the session, the SMF consults UDR segment 145, UDR segment 155, or UDR segment 165 to get details such as the user's service profile, QoS rules, and any data routing configurations. This information allows the SMF to correctly establish and manage the network session according to the user's subscription and policy requirements.

Alternatively, in provisioning call flows, a customer relationship management (CRM) client (not shown) directly or indirectly accesses the UDR segments through a provisioning gateway on each segment. The CRM client is responsible for handling new customer onboarding, creating and loading profiles, subscription changes, managing customer data, and the like. In some embodiments, the CRM client does not directly interact with the UDR segments at the protocol level but plays an important role in managing subscription data that eventually gets updated or added to the UDR. In some examples, when a customer requests to add a new service or modify an existing subscription, the subscription information is first updated with the CRM client, which may involve adding new services, changing plans, updating personal information, and the like. Changes made in the CRM client may then be passed to a provisioning system or service orchestration layer, which is responsible for implementing the service changes across the various network systems and databases, including UDR segment 145, UDR segment 155, and UDR segment 165.

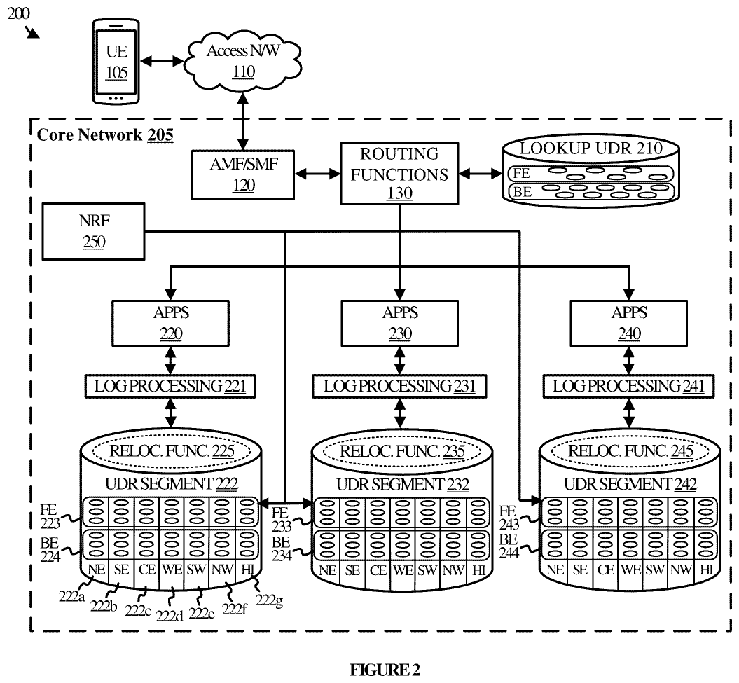

FIG. 2 illustrates communication network 200, which is representative of the network infrastructure disclosed herein in which the UDR segments are further divided into subsegments. Communication network 200 may deliver the same services as communication network 100, but where each UDR segment is further segmented into two or more subsegments. Communication network 200 further includes supporting architecture for the sub-segmented UDR implementation. Communication network 200 includes UE 105, access network 110, and core network 205. Core network 205 includes AMF/SMF 120, routing functions 130, lookup UDR 210, applications 220, log processing function 221, UDR segment 222, relocation function 225, applications 230, log processing function 231, UDR segment 232, relocation function 235, applications 240, log processing function 241, UDR segment 242, relocation function 245, and network resource function (NRF) 250. In some embodiments, the relocation functions (i.e., relocation function 225, relocation function 235, and relocation function 245) are hosted on their respective UDR segments (i.e., UDR segment 222, UDR segment 232, and UDR segment 242), while in other embodiments, these relocation functions may be hosted externally from their respective UDR segments. In other embodiments, relocation function 225, relocation function 235, and relocation function 245 may be combined into a single relocation function responsible for performing relocations across all UDR segments of core network 205. Similarly, in some alternative embodiments, log processing function 221, log processing function 231, and log processing function 241 may be combined into a single log processing function for performing log processing across all UDR segments of core network 205.

UDR segment 222 includes front end (FE) 223 and back end (BE) 224, UDR segment 232 includes include FE 233 and BE 234, and UDR segment 242 includes FE 243 and BE 244. Each of UDR segment 222, UDR segment 232, and UDR segment 242 includes a northeast (NE), southeast (SE), central (CE), west (WE), southwest (SW), northwest (NW), and Hawaii (HI) subsegment, corresponding to geographic regions being served by core network 205. UDR segment 222 includes NE subsegment 222a, SE subsegment 222b, CE subsegment 222c, WE subsegment 222d, SW subsegment 222e, NW subsegment 222f, and HI subsegment 222g. Lookup UDR 210 also includes an access layer (i.e., front end) and storage layer (i.e., back end). In other examples, communication network 200 may include additional or different elements than those illustrated in FIG. 2.

In the example of FIG. 2, UDR segment 222, UDR segment 232, and UDR segment 242 together store all subscriber profiles for users on communication network 200. The subscriber profiles stored in UDR segment 222, UDR segment 232, and UDR segment 242 include service attributes that define the level of service to be provided to users. For example, the subscriber profile for UE 105 still includes data indicating the QoS, bitrate, latency, mobility, policies, network policy authorization, and/or other metrics defining the level of service associated with UE 105. The entire subscriber profile associated with UE 105, however, is stored on only one UDR segment. In the present example, the entire subscriber profile for UE 105 is stored in UDR segment 222. Network entities within communication network 200 may therefore read the service attributes associated with UE 105 stored in UDR segment 222 to provide wireless data services to users over access network 110.

In addition to being stored in one of the UDR segments (i.e., UDR segment 222, UDR segment 232, or UDR segment 242), the subscriber profile associated with UE 105 is stored on one UDR subsegment. In the present example, the subscriber profile associated with UE 105 is stored in NE subsegment 222a, because the subscriber associated with UE 105 resides in the northeast geographic region (e.g., Maine). The subscriber associated with UE 105 may have, in some examples, registered UE 105 in the northeast region and currently accesses core network 205 from the northeast region. In the present example, each UDR segment is sub-segmented based on geographic regions. These regions, in some examples, are based on the regions defined for the edge nodes of core network 205 (e.g., MME, AMF, eNodeB, gNodeB, etc.). However, in other embodiments, UDR segments may be sub-segmented based on a variety of other criteria including but not limited to subscription type, market region, subscription details, IMSI number, and other factors that may enable the sub-segmentation of subscriber profiles. Although each UDR segment is shown to have the same subsegments in the example of FIG. 2, different UDR segments may be sub-segmented differently than one other. For example, UDR segment 222 may include the seven subsegments shown in FIG. 2 while UDR segment 232 or UDR segment 242 may have a different number of subsegments divided based on different segmentation criteria.

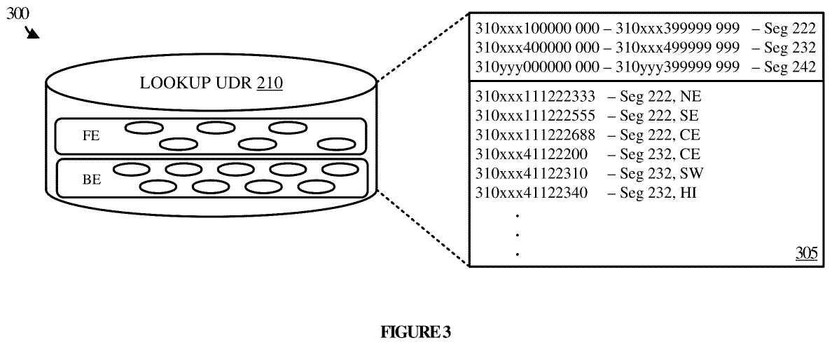

Communication network 200 differs from communication network 100 at least in part because the subscriber profiles stored on each UDR segment are further divided into multiple subsegments on each UDR segment. To support this new infrastructure, several new network elements are introduced-log processing function 221, log processing function 231, log processing function 241, relocation function 225, relocation function 235, and relocation function 245. Each of log processing function 221, log processing function 231, and log processing function 241 is responsible for processing access logs (i.e., accesses, registrations, re-registrations, and/or similar interactions with each of their respective UDR segments). Each of relocation function 225, relocation function, 235, and relocation function 245 are responsible for relocating subscriptions between subsegments of their respective UDR segments based on instructions received from their respective log processing functions. Additionally, lookup UDR 210 differs from lookup UDR 135 at least in part because lookup UDR 210 stores information not only indicating which UDR segment is hosting each subscriber profile, but also stores information indicating which subsegment of which UDR each subscriber profile is stored in (as shown in more detail in FIG. 3).

Thus, log processing function 221 and relocation function 225 work together to manage what subsegment each subscriber profile is currently stored in. Subscriber profiles, however, are not locked into a single subsegment once they are initially registered. After a user device is initially registered in a first subsegment (e.g., NE subsegment 222a) the associated subscriber profile may be relocated to a different subsegment of UDR segment 222 by relocation function 225 in response to instructions from log processing function 221 upon detecting a triggering event. Log processing function 221 triggers a relocation either upon a trigger generated by edge core nodes or by parsing the enhanced logs for such nodes.

As previously discussed, in some embodiments, subscriber profiles may be sub-segmented according to geographic region. In such an embodiment, a subscriber profile may be initially registered in the subsegment associated with the region where the associated device was registered. However, if the device associated with the subscriber profile begins accessing core network 205 from a different geographic region, the location change is detected by log processing function 221 the first time the device accesses core network 205 from the new region. Once the change is detected, log processing function 221 instructs relocation function 225 to relocate the subscriber profile from the original subsegment to the subsegment associated with the new geographic region.

In addition to the log processing functions, relocation functions, and enhanced lookup UDR, the segmented applications (i.e., applications 220, applications 230, and application 240) are enhanced in accordance with the present technology to provide subscription and region details to their respective log processing functions upon registrations, accesses, and the like. The UDR applications (e.g., applications 220), in some embodiments, use NRF 250 for information about the FE nodes available for different subsegments. NRF 250 stores information regarding the availability and use of FE nodes and thus provides the information indicating which FE(s) to query for the requested data.

For example, the subscriber profile associated with UE 105 may be stored in NE subsegment 222a of UDR segment 222 because the device was initially registered in Boston, MA and the recent accesses from UE 105 have originated in the Boston area. However, if UE 105 travels from Boston to Las Vegas, NV, log processing function 221 will detect that the request originated from the WE geographic region associated with WE subsegment 222d upon receiving information about the request from applications 220. In response to the first request from UE 105 in the WE region, UDR subsegment responds to the request with the requested subscriber information from NE subsegment 222a. However, upon receiving the request, log processing function 221 initiates the relocation of the subscriber profile associated with UE 105 from NE subsegment 222a to WE subsegment 222d. Log processing function 221 instructs relocation function 225 to perform the relocation job and relocation function 225 moves the subscriber profile from NE subsegment 222a to WE subsegment 222d. Relocation function 225, upon moving the subscriber profile, also updates lookup UDR 210 with the latest details on which subsegment is currently storing the subscriber profile associated with UE 105. Thus, upon a subsequent request from UE 105 in the WE region, UDR segment 222 responds to the request with the requested subscriber information from WE subsegment 222d.

As previously mentioned, each UDR segment may be further sub-segmented based on geographic regions. These regions, in some examples, are based on the regions defined for the edge nodes of core network 205 (e.g., MME, AMF, eNodeB, gNodeB, etc.). Thus, to subsegment each UDR segment, the front end and back end nodes of each UDR segment are sub-segmented into the subsegments. For example, UDR segment 222 includes FE 223 and BE 224. FE 223 is sub-segmented into the same seven subsegments as BE 224 (i.e., NE subsegment 222a, SE subsegment 222b, CE subsegment 222c, WE subsegment 222d, SW subsegment 222e, NW subsegment 222f, and HI subsegment 222g).

In accordance with FIG. 2, each UDR segment includes a front end and a back end, representing front end and back end nodes. For example, UDR segment 222 includes front end 223 and back end 224. On the front end (i.e., access layer), node allocations may be re-configured between subsegments according to, in some examples, traffic requirements. On the back end, storage nodes can be independently expanded based on the requirements of each subsegment.

Thus, in an access call flow (i.e., southbound) in accordance with the example of FIG. 2, UE 105 may try to connect to the network by turning on or moving into an area covered by a 5G network. UE 105 first establishes a radio connection over access network 110, specifically with the nearest gNodeB (gNB). Once the initial radio connection is established, UE 105 undergoes a registration process with core network 205. This process is managed by the AMF (i.e., AMF/SMF 120) within core network 205. UE 105 sends a registration request, which includes its identity and other relevant information, to the AMF via the gNB. The AMF coordinates with other core network functions such as the AUSF (not shown) and the UDR to authenticate UE 105. The AMF uses routing functions 130 (e.g., SCP, DRA, SLF, etc.) to route its request to the UDR segment storing subscription information for UE 105. In some examples, the SCP or DRA routing functions talk to a subscriber location function (SLF) to identify the UDR segment and subsegment hosting the subscription information for UE 105. The SLF, or another routing function, identifies the correct UDR segment and subsegment hosting the subscription information for UE 105 by checking lookup UDR 210. One of the routing functions then routes the traffic through the application segment associated with the identified UDR segment. In accordance with the present technology, the routing function(s) provides information to the application segment about which segment and which sub-segment is hosting the requested subscriber information. For example, if lookup UDR 210 indicates that the subscription information associated with UE 105 is stored in NE subsegment 222a of UDR segment 222, one or more routing functions of routing function 130 routes the traffic through applications 220 to obtain the data requested by AMF/SMF 120 from the identified UDR subsegment. When the data is obtained from the identified subsegment of UDR segment 222 by applications 220, the event is found by log processing function 221.

When the UDR segment obtains the requested authentication data for UE 105, which includes information for generating authentication vectors, this information is provided back to the AMF. Authentication vectors may then be generated, in some examples, by the AUSF and may include a random challenge (RAND), an expected response (XRES), an authentication token (AUTN), and/or other parameters used for securing the communication.

After authentication, UE 105 requests to establish a data session to access network services. This request is managed by the SMF of core network 205. The SMF sets up the session and assigns network resources, including selecting a UPF for handling UE 105's data traffic. Once connected, UE 105 can use various 5G network services such as high-speed internet, voice, video, and other data services that may be provided by the network operator and/or service provider.

Although the UDR is segmented into three segments in the example of FIG. 2, the UDR may be split up into any number of two or more segments in accordance with the technology disclosed herein, including but not limited to three, four, or five segments. The splitting of the UDR (i.e., which segment each subscription profile is hosted in) may be based on any type of business logic or other factor. In some examples, the UDR segments may be split according to subscription type (e.g., wholesale, pre-paid, retail, etc.). In such an example, some subscription types will be hosted on UDR segment 222, while other subscription types are hosted on UDR segment 232 and/or UDR segment 242. In this way, if one service is experiencing issues, other services will not be affected. Similarly, although the UDR segments are sub-segmented into seven subsegments in the example of FIG. 2, each UDR segment may be sub-segmented into any number of two or more subsegments in accordance with the technology disclosed herein. The sub-segmentation of the UDR segments may be based on any type of business logic, regional information, or other criteria.

Alternatively, provisioning call flows in accordance with the example of FIG. 2 are largely the same as described with respect to FIG. 1, but the initial subsegment for a subscription is assigned at the time the subscription is provisioned. The subsegment may be assigned based on, for example, the provisioning location (e.g., zip code, address, etc.). Core network 205, a CRM client, and/or any provisioning orchestrators may communicate over various links that use metallic links, glass fibers, radio channels, or some other communication media. The links use Fifth Generation Core (5GC), Evolved Packet Core (EPC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or other data communication protocols. Core network 205, a CRM client, and a provisioning orchestrator may comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, network functions, and multimedia functions. The microprocessors retrieve the software from the memories and execute the software to drive the operation of communication network 200 as described herein.

FIG. 3 illustrates UDR lookup environment 300, which includes lookup UDR 210. Lookup UDR 210 includes stores data 305. Data 305 includes data indicating where each subscriber profile in communication network 200 is stored. Thus, data 305 includes information regarding which UDR segment (e.g., UDR segment 222, UDR segment 232, or UDR segment 242) each subscriber profile is stored in as well as information regarding which subsegment of the identified UDR segment each subscriber profile is stored in. In the example of FIG. 3, subscriber profiles are divided across UDR segment according to IMSI values but may be divided according to other criteria in other examples. Additionally, the subsegment is indicated for each subscriber profile within each UDR segment. In the example of FIG. 3, subscriber profiles are divided into subsegments according to geographic region but may be divided based on different criteria in other examples.

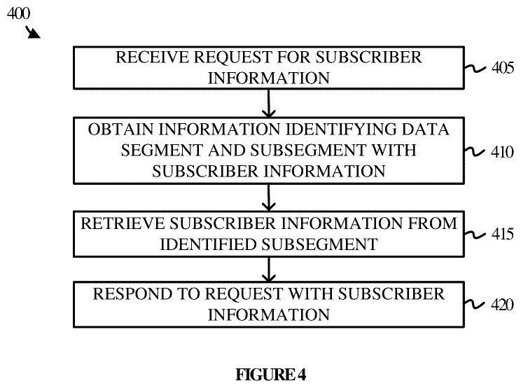

FIG. 4 illustrates process 400. Process 400 is an exemplary operation of an access call flow in communication network 200. The operations may vary in other examples. The operations of process 400, in some examples, are performed by one or more components of core network 205. In some examples, the operations of process 400 are performed by one or more routing functions of routing functions 130 of core network 205. The operations of process 400 include receiving a request for subscriber information (step 405). The requested subscriber information is associated with a subscriber stored in a database segment of a plurality of database segments. Each database segment of the plurality of database segments stores a different portion of subscriber profiles stored across the plurality of database segments. Additionally, each database segment of the plurality of database segments is divided into two or more subsegments. In some examples, one or more routing functions of routing functions 130 receives a request from AMF/SMF 120. However, the request originates at UE 105 and is sent to the AMF of AMF/SMF 120 via a gNB of access network 110. The request, in some examples, includes the identity of UE 105 and other relevant information. The request is then sent to one of UDR segment 222, UDR segment 232, or UDR segment 242 via one or more segment applications (i.e., applications 220, applications 230, or applications 240).

The operations of process 400 further include, in response to receiving the request, obtaining information from lookup UDR 210 indicating that the subscriber information associated with the subscriber is stored in an identified subsegment of an identified database segment of the plurality of database segments (step 410). In the example of FIG. 2, one or more routing functions of routing functions 130, in response to receiving the request via AMF/SMF 120, obtains information from lookup UDR 210 indicating that the subscriber information associated with UE 105 is stored in UDR segment 222.

The operations of process 400 further include, upon obtaining the information indicating that the subscriber information is stored in the identified subsegment of the identified database segment, retrieving the subscriber information from the identified subsegment (step 415). In the example of FIG. 2, one or more routing functions of routing functions 130, upon obtaining the information indicating that the subscriber information for UE 105 is stored in NE subsegment 222a of UDR segment 222, retrieves the subscriber information for UE 105 from NE subsegment 222a of UDR segment 222 through applications 220.

The operations of process 400 further include responding to the request with the subscriber information associated with the subscriber (step 420). In the example of FIG. 2, one or more routing functions of routing functions 130 responds to AMF/SMF 120 with the subscriber information from NE subsegment 222a of UDR segment 222. After authentication by the AMF and/or AUSF, UE 105 may establish a data session to access services of core network 205.

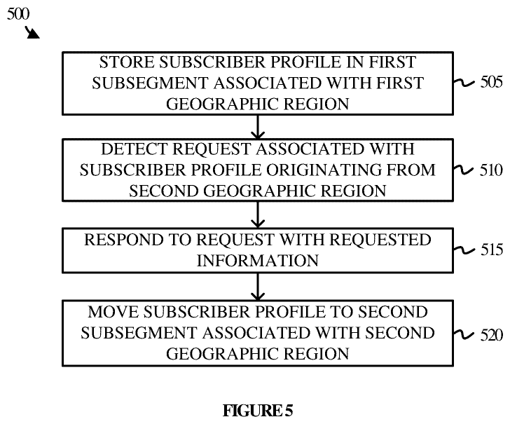

FIG. 5 illustrates process 500. Process 500 is an exemplary operation of relocating subscriber information upon receiving a request from a different geographic region in communication network 200. The operations may vary in other examples. The operations of process 500, in some examples, are performed by various components of core network 205 including but not limited to applications 220, log processing function 221, UDR segment 222, relocation function 225, applications 230, log processing function 231, UDR segment 232, relocation function 235, applications 240, log processing function 241, UDR segment 242, and/or relocation function 245. In the example of FIG. 5, subscriber profiles are stored in subsegments divided based on geographic regions. However, subscriber profiles may be divided into subsegments based on other criteria in other examples.

The operations of process 500 include storing a subscriber profile in a first subsegment associated with a first geographic region (step 505). In the example of FIG. 2, one or more applications of applications 220 stores the subscriber profile associated with UE 105 in NE subsegment 222a of UDR segment 222 because UE 105 last registered on the network from the northeast geographic region. The one or more applications of application 220 also record the information about where the subscriber profile is stored in lookup UDR 210. The subscriber profile may be stored in NE subsegment 222a of UDR segment 222 based on, in some examples, the geographic region in which UE 105 was activated, the geographic region from which UE 105 last accessed core network 205, IMSI number of UE 105, and/or subscription type.

The operations of process 500 further include detecting a request associated with the subscriber profile originating from a second geographic region (step 510). The second geographic region, in the example of FIG. 5, is the northwest region associated with NW subsegment 222f. The second request originates from the northwest region because UE 105 may have traveled from the northeast geographic region (e.g., New York) to the northwest geographic region (e.g., Seattle). Step 510 of process 500 is performed by log processing function 221, in some examples. In accordance with the present disclosure, the applications of applications 220 are enhanced from existing functionality to provide subscription and region details to log processing function 221 when information is requested from UDR segment 222.

The operations of process 500 further include responding to the request with the requested information (step 515), wherein responding to the request includes obtaining the subscriber information from NE subsegment 222a of UDR segment 222 and providing it to AMF/SMF 120. Step 515 of process 500 is performed by one or more components of core network 205 which may include applications 220 and/or routing functions 130. In the example of process 500, the request detected in step 510 is the first request received from UE 105 from the second geographic region since the subscriber profile was stored in NE subsegment 222a. Thus, the subscriber profile is still stored in NE subsegment 222a in step 515.

The operations of process 500 further include moving the subscriber profile associated with UE 105 to the subsegment associated with the second geographic region (step 520). Continuing with the example of FIG. 2, the subscriber profile associated with UE 105 is moved from NE subsegment 222a to NW subsegment 222f of UDR segment 222 by relocation function 225 upon relocation function 225 receiving instructions from log processing function 221 upon detecting that the request originated from the second geographic region in step 510. Once the subscriber profile is moved to NW subsegment 222f, future requests will be responded to with the subscription information obtained from NW subsegment 222f instead of NE subsegment 222a. In addition to moving the subscriber profile to NW subsegment 222f, one or more components of core network 205 will update lookup UDR 210 to indicate that the subscriber profile associated with UE 105 is now stored in NW subsegment 222f of UDR segment 222. Relocation function 225 is responsible for updating lookup UDR 210 in some examples.

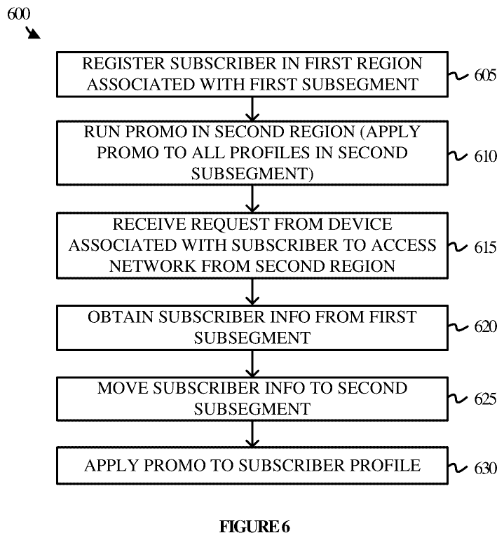

FIG. 6 illustrates process 600. Process 600 illustrates one example of how the technology disclosed herein improves functionality within wireless communication networks. More specifically, process 600 provides an example of how the technology disclosed herein can be leveraged to simplify the application of promotions based on geographic region. The operations of process 600 may vary in other examples. The operations of process 600, in some examples, are performed by various components of core network 205 and/or communication network 200. The operations include registering, by one or more components of the core network, a subscriber associated with a user device in a first geographical region (e.g., the NE geographic region), wherein the first geographic region is associated with a first UDR subsegment of a UDR segment (step 605). In the example of FIG. 2, UE 105 may register with core network 205 from the NE geographic region associated with NE subsegment 222a of UDR segment 222.

The operations of process 600 further include running a promotion in a second geographical region (e.g., the WE region) (step 610). To run a promotion in the second geographic region, the promotion is applied to all subscriber profiles stored in the subsegment associated with the second geographic region. In the example of FIG. 2, a promotion may be applied to all subscriber profiles in WE subsegment 222d of UDR segment 222. The promotion may be applied to all subscriber profiles in WE subsegment 222d by one or more applications of applications 220, in some examples. The promotion, in some examples, may include a temporary subscription benefit, such as free unlimited hotspot use for all subscribers in the WE region. In step 615, one or more components of the core network receive a request from the device associated with the subscriber to access the network from a second geographic region (e.g., the WE region). Such a request may arise due to the subscriber associated with the device traveling to the second geographic region and accessing the network from their device in the second geographic region. In the example of FIG. 2, the subscriber associated with UE 105 may travel to the WE region and, upon arriving, attempt to access data via UE 105.

The operations further include, in response to the request, obtaining the subscriber information associated with the device from the first UDR subsegment associated with the first geographic region (e.g., the NE region) and responding to the request with the subscriber information (step 620). In the example of FIG. 2, one or more components of core network 205 may obtain the subscriber information associated with UE 105 from NE subsegment 222a of UDR segment 222, even though the request originated from the WE region. The subscriber information is obtained by one or more routing functions of routing functions 130 via one or more applications of applications 220 and may be provided back to the AMF or the SMF of AMF/SMF 120.

The operations further comprise, as described in reference to FIG. 5, moving the subscriber information to the second UDR subsegment associated with the second geographic region (e.g., the WE geographic region) (step 625). In the example of FIG. 2, relocation function 225 may move the subscriber information associated with UE 105 from NE subsegment 222a to WE subsegment 222d of UDR segment 222 in response to receiving instructions from log processing function 221. Relocation function 225 may also update lookup UDR 210 to reflect the change in where the subscriber information is stored. Once the subscriber information is moved to the second UDR subsegment (e.g., the WE subsegment) the promotion applied to the WE subsegment is automatically applied to the subscriber profile in step 630. Thus, in the example of FIG. 2, UE 105 may automatically have access to the free unlimited hotspot promotion associated with the WE region upon the profile being relocated to WE subsegment 222d.

In some examples, operators may wish to run a promotional event in anticipation of live events happening in certain geographic regions. For example, if a known event is coming up in Las Vegas, NV, such as a national football championship game (i.e., the Superbowl), and a large influx of visitors are expected to travel to the Las Vegas area for the game, operators may wish to prepare network capacity for the large influx in anticipation of the event (i.e., in the West region/subsegments). In such a case, the present technology enables operators to easily reconfigure access (FE) and backend (BE) nodes to increase capacity for the upcoming surge in traffic. Operators can shift FE and BE nodes between subsegments to increase the network capacity for the geographic region encompassing Las Vegas. The shifted FE and BE information is updated and reflected in the NRF.

As subscribers start to arrive in the Las Vegas region for the game, their devices begin registering into the edge core nodes for the West market region. As described in the examples above, the log processing function detects that the devices are not registered in the subsegment associated with the West region and triggers the relocation of the subscriber profiles to the West subsegment (e.g., instructs the relocation function). The relocation function then relocates the subscribers to the updated subsegment and updates the lookup UDR with the updated subsegment information. From that point on until the subscribers move to another market region, all access and provisioning requests for the relocated subscribers are handled from the market/location specific subsegment of the UDR, which is already configured to handle the increased traffic. Additionally, any negative impacts (e.g., overloads, network issues) are restricted to the specific UDR subsegment and other subsegments are not affected.

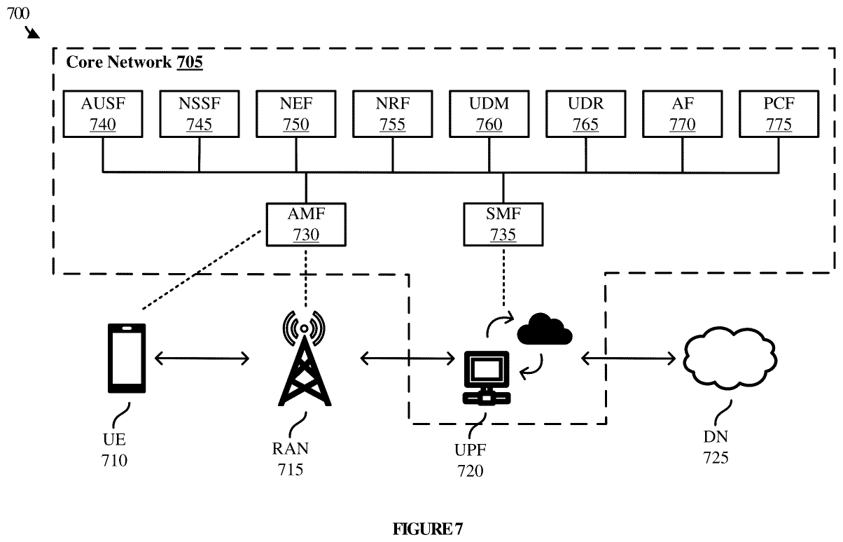

FIG. 7 illustrates 5G communication network 700. 5G communication network 700 is representative of a 5G communication network as disclosed herein having multiple UDR segments and/or UDR subsegments. 5G communication network 700 may be representative of communication network 200 illustrated in FIG. 2, in some examples. 5G communication network 700 includes core network 705, user equipment (UE) 710, radio access network (RAN) 715, user plane function (UPF) 720, and data network (DN) 725. Core network 705 includes AMF 730, SMF 735, Authentication Server Function (AUSF) 740, Network Slice Selection Function (NSSF) 745, Network Exposure Function (NEF) 750, Network Repository Function (NRF) 755, Unified Data Management (UDM) 760, Unified Data Repository (UDR) 765, Application Function (AF) 770, and Policy Control Function (PCF) 775. In other examples, 5G communication network 700 may include different or additional elements than those illustrated in FIG. 7 including but not limited to a session communication proxy (SCP), a migration function, a provisioning orchestrator, a CRM client, and the like.

UE 710, in some examples, is representative of UE 105 from the preceding Figures. RAN 715, in some examples, is representative of access network 110 from the preceding Figures. Core network 705, in some examples, is representative of core network 115 and/or core network 205 from the preceding Figures. AMF 730 and SMF 735, in some examples, are representative of AMF/SMF 120 from the preceding Figures. UDR 765, in some examples, is representative of any one of or combination of UDR segment 145, UDR segment 155, UDR segment 165, UDR segment 222, UDR segment 232, and/or UDR segment 242. In some cases, UDR 765 is split into multiple segments such as UDR segment 222, UDR segment 232, and UDR segment 242 from FIG. 2.

AMF 730 is responsible for access and mobility management including the initial registration of devices, authentication, tracking area management, and ensuring that users remain connected as they move through the network. AMF 730 serves as the point of contact for a user device (e.g., UE 710) when it tries to connect to the 5G network (e.g., 5G communication network 700). AMF 730 manages the establishment, maintenance, and termination of the connection between UE 710 and core network 705. SMF 735 is responsible for session management including establishing, modifying, and releasing sessions (which comprise of one or more data flows). SMF 735 also selects and manages the user plane functions, handles aspects of IP address allocation, and maintains the rules for how data should be routed and reported. SMF 735 ensures that data can be successfully transmitted between UE 710 and the internet or other network services.

AUSF 740 is also responsible for aspects of user authentication. AUSF, in part, generates and validates authentication vectors to ensure that the requesting UE is a legitimate subscriber of 5G communication network 700. Upon successful authentication, AUSF 740 contributes to establishing a secure communication channel between UE 710 and core network 705 by facilitating the generation and distribution of security keys. AUSF 740 may also support network slicing by authenticating access to different network slices based on user subscription. AUSF 740 also supports roaming by interacting with corresponding authentication functions in other networks.

NSSF 745 is responsible for selecting the appropriate network slice for UE 710 based on UE 710's subscription data and requested service. This may involve determining which slice or slices are best suited to meet the specific service requirements and UE 710's subscription profile. NSSF 745 is also responsible for enforcing policies related to network slice access, managing information about the network slices, and interacting with other core network functions to ensure that UE 710 is connected to the correct slice and that slice-specific rules are applied.

NEF 750 plays a role in securely exposing the capabilities of core network 705 to external applications and services. NEF 750 may perform functions such as providing standardized APIs for third-party services to access specific network capabilities or information and ensuring that the exposure of network capabilities and user data is managed securely and user privacy is maintained. NRF 755 acts as a central registry and discovery service for the network functions within core network 705. NRF 755 allows other network functions to register their services and discover the services provided by other network functions, maintains up-to-date information on the services offered by different network functions, supports load balancing and fault tolerance mechanisms within the network, and supports the scalability of the network.

UDM 760 is a central entity for managing subscriber data and authentication information. UDM 760 stores and manages subscription-specific information and is responsible for handling the authentication and authorization of users trying to access the network. Although not directly managing sessions, UDM 760 provides necessary information to other network functions, such as AMF 730 and SMF 735, to assist in session establishment and management based on the subscriber's data. UDM 760 also supports seamless service continuity and roaming by managing user identities and security information across different types of networks.

UDR 765 acts as a database (or multiple databases in the case of FIG. 1 and FIG. 2) for storing and managing structured subscriber data and service information. UDR 765 manages access to subscription data for other network functions such as AMF 730, SMF 735, and UDM 760. AF 770 is representative of external applications and services that may need to interact with core network 705 for various purposes. PCF 775 is responsible for policy management, which involves creating and enforcing policy rules for network behavior and user data transmission.

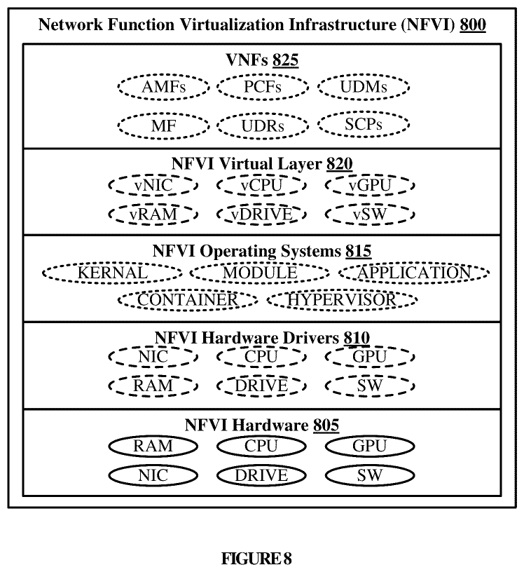

FIG. 8 illustrates Network Function Virtualization Infrastructure (NFVI) 800 in a 4G or 5G wireless communication network. NFVI 800 represents an example of core network 115, core network 205, and/or core network 705 from the preceding Figures, although these core networks may differ in architecture and implementation. NFVI 800 comprises NFVI hardware 805, NFVI hardware drivers 810, NFVI operating systems 815, NFVI virtual layer 820, and NFVI Virtual Network Functions (VNFs) 825. NFVI hardware 805 includes but is not limited to Network Interface Cards (NICs), CPU, GPU, RAM, Flash/Disk Drives (DRIVE), and Data Switches (SW). NFVI hardware drivers 810 includes but is not limited to software that is resident in the NIC, CPU, GPU, RAM, DRIVE, and SW. NFVI operating systems 815 includes but is not limited to kernels, modules, applications, containers, hypervisors, and the like. NFVI virtual layer 820 includes but is not limited to vNIC, vCPU, GPU, vRAM, vDRIVE, and vSW. NFVI VNFs 825 includes but is not limited to AMFs, PCFs, UDMs, SCPs, MF, and UDRs. Additional VNFs and network elements like SMF, UPF, AUSF, NSSF, NRF, EIR, NEF, and AF may also be present but are omitted from FIG. 8 for the sake of clarity.

NFVI 800, in some embodiments, refers to the physical and virtual resources that support the deployment, operation, and management of virtual network functions within core network 115, core network 205, and/or core network 705. NFVI 800 includes the physical servers, storage, and network switches that provide the basic computational, storage, and networking capabilities. These resources, in some examples, are located in data centers and may be distributed or centralized. NFVI virtual layer 820 includes software that abstracts the hardware resources and allows them to be shared among different VNFs. This may involve the leveraging of one or more hypervisors or container management systems that create and manage virtual machines or containers.

NFVI 800 includes, generally, virtual counterparts to the physical resources (e.g., virtual CPUs, virtual memory, virtual networks) that are allocated to the VNFs. These resources can be scaled up or down as needed, providing flexibility and scalability. Although not a part of NFVI 800 per se, NFVI 800 may be closely integrated with management and orchestration (MANO) frameworks that handle the deployment, connection, scaling, and management of virtual network functions on NFVI 800. This may include functions such as virtual network function manager (VNFM), virtualized infrastructure manager (VIM), and network function virtualization orchestrator (NFVO).

NFVI 800, in the context of a 5G network, enables the deployment of network services as software instances, making the network more adaptable and efficient. NFVI 800 supports 5G goals of high scalability, flexibility, and resource efficiency, thereby enabling rapid deployment and dynamic scaling of network services to meet changing demands. The virtualized nature of NFVI 800 aligns with the 5G goals of achieving a software-defined network architecture, which can support a wide range of services from high-speed internet to large IoT deployments.

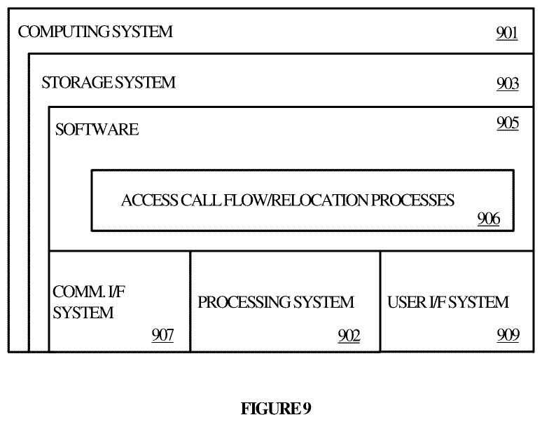

FIG. 9 illustrates computing system 901, which is representative of any system or collection of systems in which the various processes, programs, services, and scenarios disclosed herein may be implemented. Examples of computing system 901 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements access call flow and/or relocation processes 906, which is representative of the access call flow and/or subscriber relocation processes discussed with respect to the preceding Figures, such as process 400, process 500, and process 600. Software 905 may also include and implement provisioning call flow processes. When executed by processing system 902, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including access call flow and/or relocation processes 906) may be implemented in program instructions and among other functions may, when executed by processing system 902, direct processing system 902 to operate as described with respect to the various operational scenarios, sequences, and processes illustrated herein. For example, software 905 may include program instructions for implementing the access call flow or subscriber relocation processes in a multiple UDR segment/subsegment environment as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to perform the 4G and 5G network processes described herein. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary, etc.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a wireless communication network, the method comprising:
receiving a request for subscriber information associated with a subscriber stored in a database segment of a plurality of database segments, wherein each database segment of the plurality of database segments stores a different portion of subscriber profiles stored across the plurality of database segments;
in response to the request, obtaining information indicating that the subscriber information associated with the subscriber is stored in an identified subsegment of the database segment, wherein the database segment is segmented into a plurality of subsegments;
upon obtaining the information indicating that the subscriber information associated with the subscriber is stored in the identified subsegment of the database segment, retrieving the subscriber information associated with the subscriber from the identified subsegment of the database segment; and
responding to the request with the subscriber information associated with the subscriber.

2. The method of claim 1, wherein each subsegment of plurality of the subsegments corresponds to a different geographic region and the identified subsegment of the database segment corresponds to a first geographic region.

3. The method of claim 2, further comprising applying a subscription feature to each subscriber profile currently stored in the identified subsegment corresponding to the first geographic region.

4. The method of claim 2, wherein:
the request for the subscriber information associated with subscriber is triggered by a request from a user device associated with the subscriber to access the wireless communication network; and
the request from the user device associated with the subscriber was sent from a second geographic region associated with a different subsegment of the plurality of subsegments.

5. The method of claim 4, further comprising, upon detecting that the request from the user device associated with the subscriber was sent from the second geographic region instead of the first geographic region, moving the subscriber information associated with the subscriber from the identified subsegment of the plurality of subsegments to the different subsegment of the plurality of subsegments.

6. The method of claim 5, further comprising, upon moving the subscriber information associated with the subscriber from the identified subsegment to the different subsegment of the plurality of subsegments, updating information in a lookup database to indicate that the subscriber information associated with the subscriber is stored in the different subsegment of the plurality of subsegments.

7. The method of claim 5, further comprising running a promotion in the second geographic region and, upon moving the subscriber information associated with the subscriber from the identified subsegment to the different subsegment of the plurality of subsegments, applying the promotion to a subscriber profile associated with the subscriber.

8. The method of claim 1, wherein the request is from an authentication entity of the wireless communication network and wherein the authentication entity sent the request for the subscriber information associated with the subscriber in response to receiving an authentication request associated with the subscriber.

9. The method of claim 1, wherein the wireless communication network is a Fifth Generation (5G) cellular communication network.

10. A wireless communication network comprising:
a unified data repository (UDR) comprising two or more database segments, wherein:
each database segment of the two or more database segments stores a different portion of subscriber profiles in the UDR; and
each database segment of the two or more database segments is further segmented into two or more subsegments;
a lookup database configured to store information indicating where each subscriber profile of the subscriber profiles in the UDR is stored;
at least one routing function configured to:
receive a request for subscriber information associated with a subscriber stored in a database segment of the two or more database segments;
in response to the request, obtain information from the lookup database indicating that the subscriber information associated with the subscriber is stored in an identified database segment of the two or more database segments and an identified subsegment of two or more subsegments making up the identified database segment;
upon obtaining the information indicating that the subscriber information associated with the subscriber is stored in the identified database segment and the identified subsegment, retrieve the subscriber information from the identified subsegment in the identified database segment; and
respond to the request with the subscriber information associated with the subscriber.

11. The wireless communication network of claim 10, wherein each subsegment of the two or more subsegments corresponds to a different geographic region and the identified subsegment of the database segment corresponds to a first geographic region.

12. The wireless communication network of claim 11, wherein:
the request for the subscriber information associated with subscriber is triggered by a request from a user device associated with the subscriber to access the wireless communication network; and
the request from the user device associated with the subscriber was sent from a second geographic region associated with a different subsegment of the two or more subsegments.

13. The wireless communication network of claim 12, further comprising a log processing function configured to determine that the request from the user device associated with the subscriber was sent from the second geographic region instead of the second geographic region instead of the first geographic region.

14. The wireless communication network of claim 13, further comprising a relocation function configured to move the subscriber information associated with the subscriber from the identified subsegment of the two or more subsegments to the different subsegment of the two or more subsegments.

15. The wireless communication network of claim 14, wherein the relocation function is further configured to, after moving the subscriber information associated with the subscriber from the identified subsegment of the two or more subsegments to the different subsegment of the two or more subsegments, updating the information indicating where each subscriber profile of the subscriber profiles in the UDR is stored in the lookup database to indicate that the subscriber information associated with the subscriber is stored in the different subsegment of the two or more subsegments.

16. The wireless communication network of claim 10, further comprising an authentication entity, wherein the authentication entity sent the request for the subscriber information associated with the subscriber in response to receiving an authentication request associated with the subscriber.

17. The wireless communication network of claim 10, wherein the wireless communication network is a Fifth Generation (5G) cellular communication network.

18. One or more non-transitory computer-readable storage media having program instructions stored thereon, wherein the program instructions, when executed by a computing system, direct the computing system to perform operations, the operations comprising:
receiving a request for subscriber information associated with a subscriber stored in a database segment of a plurality of database segments, wherein each database segment of the plurality of database segments stores a different portion of subscriber profiles stored across the plurality of database segments;
in response to the request, obtaining information indicating that the subscriber information associated with the subscriber is stored in an identified subsegment of the database segment, wherein the database segment is segmented into a plurality of subsegments;
upon obtaining the information indicating that the subscriber information associated with the subscriber is stored in the identified subsegment of the database segment, retrieving the subscriber information associated with the subscriber from the identified subsegment of the database segment; and
responding to the request with the subscriber information associated with the subscriber.

19. The one or more non-transitory computer-readable storage media of claim 18, wherein each subsegment of the plurality of subsegments correspond to a different geographic region and the identified subsegment of the database segment corresponds to a first geographic region.

20. The one or more non-transitory computer-readable storage media of claim 18, wherein the plurality of database segments makes up a unified database repository (UDR) associated with a wireless communication network.
